(19) United States
(12) Patent Application Publication
(10) Pub. No.: US 2013/0153480 A1
(43) Pub. Date: Jun. 20, 2013

(54) Water Filter With Inwardly Sloping Top

(71) Applicant: Tareq Risheq, Laguna Niguel, CA (US)

(72) Inventor: Tareq Risheq, Laguna Niguel, CA (US)

(73) Assignee: SimpliPure, Aliso Viejo, CA (US)

(21) Appl. No.: 13/586,221

(22) Filed: Aug. 15, 2012

Related U.S. Application Data
(63) Continuation-in-part of application No. 13/358,398, filed on Jan. 25, 2012.
Application No. 13/358,398 is a continuation-in-part of application No. 12/704,258, filed on Feb. 11, 2010, now Pat. No. 8,337,697.
(60) Provisional application No. 61/435,906, filed on Jan. 25, 2011.
(60) Provisional application No. 61/259,039, filed on Nov. 6, 2009.
(60) Provisional application No. 61/211,162, filed on Mar. 26, 2009.
(60) Provisional application No. 61/157,473, filed on Mar. 4, 2009.
(60) Provisional application No. 61/156,437, filed on Feb. 27, 2009.

(51) Int. Cl. B01D 27/04

(52) U.S. Cl. CPC B01D 27/04
USPC 210/232; 210/541; 210/435; 210/436

(57) ABSTRACT

A filter cartridge and filter for a water bottle is presented. The filter cartridge has a top member with an inwardly sloped exterior surface and at least one opening. The top member is removeably coupled with a bottom member to form an enclosure for housing a filter. The bottom member also has an opening or inlet to allow water to pass through the filter cartridge. The filter cartridge also has an outer rim with a seal (e.g., a sealing ring, etc.). The filter can comprise a frustoconical shaped portion.

This application is a continuation-in-part of: (1) application Ser. No. 13/358,398, filed on Jan. 25, 2012, which claims the benefit of priority to provisional application No. 61/435,906 filed on Jan. 25, 2011; and (2) application Ser. No. 12/704,258, filed on Feb. 11, 2010, which claims the benefit of priority to: (a) provisional application No. 61/156437, filed on Feb. 27, 2009; (b) provisional application No. 61/157473, filed on Mar. 4, 2009; (c) provisional application No. 61/211162, filed on Mar. 26, 2009, and (d) provisional application No. 61/259039, filed on Nov. 6, 2009, each of which are incorporated herein by reference.

### FIELD OF THE INVENTION

The field of the invention is water filters, and more specifically water filters for use within a water dispensing apparatus.

### BACKGROUND

Water bottles are well known in the art, and generally consist of a compressible water reservoir having a bottle neck to which a nozzle or cap is coupled. Many different water bottle designs have been developed over the years for numerous purposes. Recently, there has been a significant increase in demand for filtered water, and it is known to incorporate a filtration device within a water bottle.

For example, U.S. Pat. No. 5,609,759 to Nohren Jr. describes a water bottle having a tube of filtering material with porous side walls coupled to the cap. The tube is inserted through an open neck of the bottle. Unfortunately, Nohren's filter tube must be very long and/or contain very little filter material in order to pass through the opening of the water bottle.

U.S. Publication No. 2007/0221570 to Aregger teaches a water filter cartridge that includes a flat top cover having water inlets and a bottom member with an outlet. The cover and bottom houses several spiral channels for holding a filter material and channeling the water through the filter material. One problem with Aregger's design is that the design of the cover does not allow all excess liquid to flow back through the filter cartridge, which can cause leaking.

Nohren and Aregger and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for improved water bottle-filter configurations.

### SUMMARY OF THE INVENTION

The inventive subject matter provides apparatus, systems and methods in which a filter cartridge houses a filter and couples with a bottle opening. The filter cartridge has a top member with an inwardly sloping, preferably substantially V-shaped exterior surface. The top member mates with a bottom member to form an enclosure large enough to house a filter. The top and bottom members each have at least one opening for allowing a liquid to flow through the cartridge.

In one aspect of some embodiments, the at least one of a top member and a bottom member further includes a rim (e.g. protrusion, flange, flange having H-shaped cross-section, flange having T-shaped cross-section, etc.) and a seal (e.g. a sealing ring) disposed within or around the rim. Each flange could comprise any suitable size and shape. Examples of suitable flanges include annular flanges (e.g., having an H-shaped cross-section, a T-shaped cross-section, a rounded cross-section, a circular cross-section, any combination thereof, etc.), rectangular flanges, curved flanges, straight-line flanges, and so forth. It is contemplated that each of the top member and a bottom member could comprise a flange. In such embodiments, a seal could be disposed within or around each of the flanges, or a single seal could be disposed within both of the flanges. In another aspect of some embodiments, the top member couples to the bottom member by a snap fitting. In yet other aspects, the bottom member includes inner and outer concentric walls that form a cavity sized and dimensioned to house the filter.

In some embodiments the filter is concave and securely attached to an inner surface of the filter cartridge. The filter can be a replaceable cartridge configured to removeably couple to an inside portion of the filter cartridge. In some embodiments, the filter comprises an activated carbon, high reactivity carbon mixture (HCRM), and/or an iodinated resin. In some embodiments the filter is molded and can have a shape that is cylindrical, frustoconical, conical, rectangular, rounded, tubular, any combination thereof, or any other suitable shape. The filter is preferably capable of reducing contaminants in the liquid by at least 99%. In other embodiments, the filter comprises a mesh fabric containing filter elements capable of filtering bacteria, giardia and/or microbial cysts.

In one aspect of some embodiments, the filter cartridge also includes a pressure equalization valve or a one-way valve.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a cross section view of one embodiment of a filter cartridge for a water bottle.

FIG. 2 is a cross section view of another embodiment of a filter cartridge.

FIG. 3 is a perspective view of the filter cartridge in FIG. 2.

FIG. 4 is an exploded view of a water bottle and a filter cartridge.

FIG. 5a is a bottom-perspective view of the filter cartridge in FIG. 4.

FIG. 5b is a top-perspective view of the filter cartridge in FIG. 4.

FIGS. 5c-f are various views of the concave exterior surface of the top member of the filter cartridge in FIG. 4.

FIGS. 6a-e are various views of the bottom member of the filter cartridge in FIG. 4.

FIG. 7a is a side view of a water bottle with a cap.

FIG. 7b is a cross section view of the water bottle in FIG. 7a, showing the filter cartridge inside the bottle.

FIG. 7c is a close-up of FIG. 7b.

FIG. 8a is a cross section view of an embodiment of a filter cartridge having an inwardly sloping surface and an M-shaped cross section.

FIG. 8b is a cross section view of the filter of FIG. 8a disposed in a water bottle.

FIG. 9a is a perspective view of one embodiment of a top member of a filter cartridge.

FIG. 9b is a perspective view of one embodiment of a bottom member of a filter cartridge.

FIG. 9c is a cross section view of the bottom member of FIG. 9B.

FIG. 10 is a cross section view of one embodiment of a filter cartridge.

FIG. 11a is a perspective view of a filter outside of a filter cartridge.

FIG. 11b is a cross section view of the filter and filter cartridge of FIG. 11a.

FIG. 12 is a perspective view of a filter comprising a mesh fabric enclosing filter elements.

FIG. 13 is a cutaway view of a bottom member of a filter cartridge having a flange and a seal.

FIG. 14a is a perspective view of a filter cartridge coupled with a reservoir.

FIG. 14b is a perspective view of the filter cartridge of FIG. 14a coupled with a cap.

FIG. 15 is a cross section view of a top member having a flange and a plurality of seals.

FIG. 16 is a cross section view of a filter cartridge having a seal surrounding portions of a top member flange and a bottom member flange.

FIG. 17a is a cross section view of a frustoconical filter.

FIG. 17b is a perspective view of the filter of FIG. 17a.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

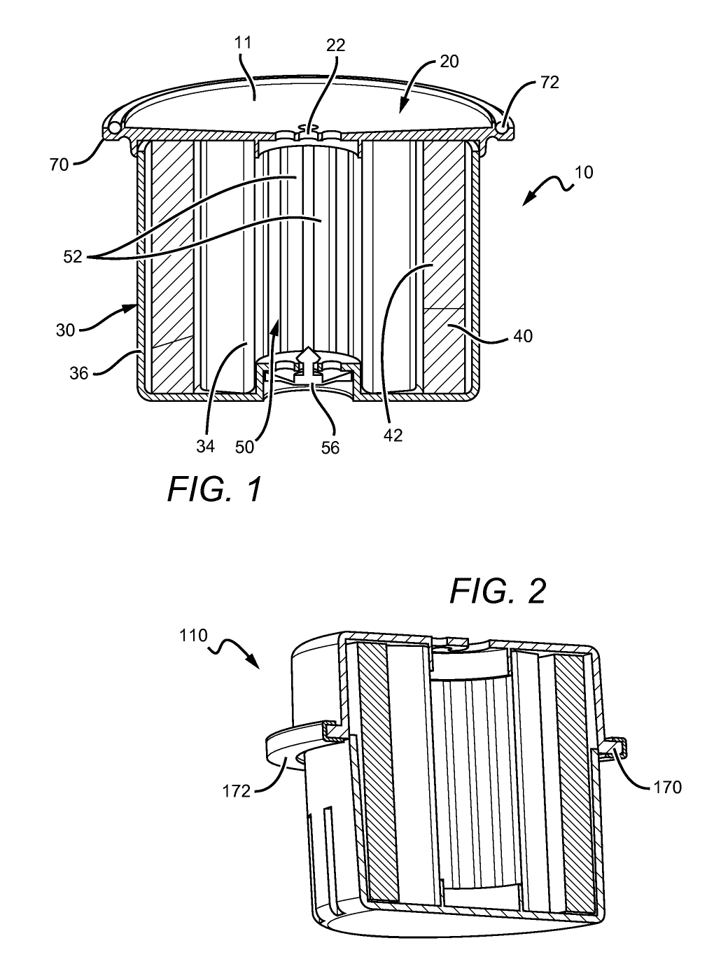

FIG. 1 shows a filter cartridge 10. Cartridge 10 includes a top member 20 having openings 22 for dispensing/draining a liquid, and a bottom member 30 having inlets 52 to allow for liquid to flow through filter 40. Cartridge 10 is designed to couple to a bottle.

It is contemplated that top member 20 and bottom member 30 can be mechanically coupled together via a snap fitting, a quick release mechanism, magnetic, or any other suitable means known in the art that are capable of coupling top member 20 with bottom member 30. Each of the top member and bottom member of a filter cartridge could be of any shape suitable to hold a filter. For example, where a filter is frustoconical in shape, it is contemplated that an inner wall or an outer wall of a bottom member can be frustoconical in shape.

Cartridge 10 has a rim 70. Rim 70 aids in either the coupling the top member 20 with the bottom member 30 or for seating /coupling cartridge 10 to a bottle top or reservoir. Rim 70 includes a seal 72 disposed within a channel of rim 70 to aid in leakage prevention when cartridge 10 is coupled with a bottle.

As shown in FIG. 1, top member 20 has an exterior surface 11 that permits excess liquid to drain back through filter 40 via openings 22 when cartridge 10 is not in use. Bottom member 30 includes inner and outer concentric walls 34 and 36 that form a filter holding portion 42 and an inner depression 50 having one or more inlets 52. Bottom member 30 includes air vent 56 and additional inlets on the exterior surface.

Filter cartridge 10 can be constructed out of polyethylene, polypropylene, polyvinyl chloride, polyethylene terepthalate, or any other suitable natural and synthetic polymer. Filter cartridge 10 is sized and dimensioned to house filter 40.

Filter 40 is preferably constructed out of at least one of high reactivity carbon mixture (HCRM), activated carbon, and iodinated resin, or any other suitable compositions for filtering water, or combinations thereof. High Reactivity Carbon Mixture (HRCM) is manufactured by a unique method of cold autocatalytic decomposition of graphite (See Appendix 1). HRCM has an extremely large specific surface area (2,500 m2 per 1 gram of HRCM). The surface of this material consists of atomic layers of cyclic carbon (graphenes) with damaged molecular bonds. HRCM is a chemically inert substance, electro conductive, hydrophobic, stable in corrosive environments and ecologically clean. HRCM consists of 99.4% pure carbon materials with a bulk density of 0.01-0.001 g/cm3 (depending on the manufacturing method). Filter 40 can have a pore size of at least 0.2 to 100 microns, preferably 1 to 25 microns.

It is also contemplated that filter 40 can further comprise a woven or non-woven mesh fabric to aid in the filtration of viruses, bacteria, giardia, microbial cysts and other submicron particles. For example, such as a nonwoven mesh composed of nano-fibers, such as AHLSTROM DISRUPTOR® Nonwoven Filter Media, which has nano-fibers that are 2 nm in diameter and 250 nm in length, and thus have a surface area of >500 gsm, and which create a natural positive charge that aids in the absorption of the contaminant.

In preferred embodiments, filter 40 can be molded into a cone, concave, or frustoconical shape, but it is also contemplated that filter 40 could be molded into a flat disc, or any other size and shape. It is also contemplated that filter 40 could be in a granular form and contained within a mesh bag or other holding material.

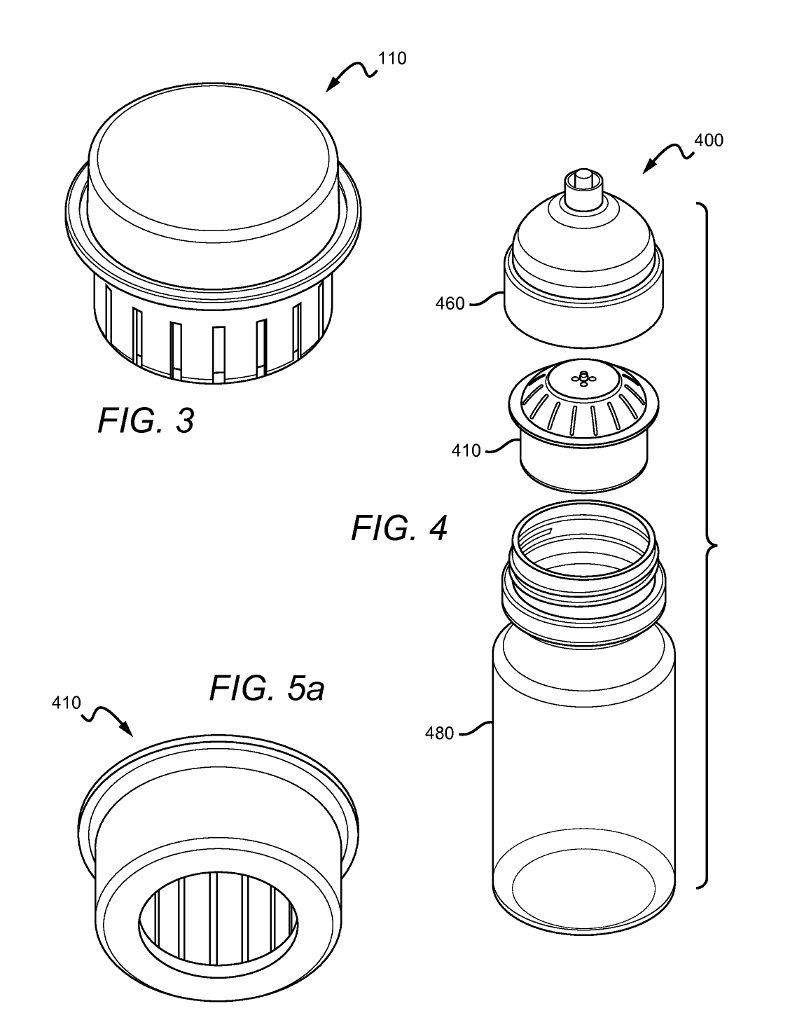

FIG. 2 shows a cross section view of a filter cartridge 110. FIG. 3 shows a perspective view of cartridge 110. Cartridge 110 is similar to cartridge 10 except that cartridge 110 has a rim 170 and seal 172 that is located at a lower position than rim 70 and seal 72 of cartridge 10. Seal 172 comprises a ring with a c-shaped cross section that fits over at least some of the surface area of rim 170. Seal 172 could comprise cross sectional shapes other htan c-shapes depending on the configuration of rim 170 in order to provide a seal. Seal 172 is generally at least 2 mm in thickness, but could be thinner or thicker to best prevent leakage depending on the configuration of the. It is further contemplated that two or more seals could be disposed within or around a rim of cartridge.The location and size of the rim and seal can vary, depending on the particular application (e.g., size of bottle opening).

FIG. 4 depicts a bottle 400 having cap 460 and a filter cartridge 410. Cartridge 410 has a cylindrical shape, however, any size and shape suitable for coupling with a bottle opening or bottle reservoir are contemplated. The top member of cartridge 410 is depicted as having openings (e.g., inlets) to allow liquid to freely flow through the filter housed within cartridge 410. Cartridge 410 has a rim that couples with the outer diameter of the opening of reservoir 480. Cartridge 410 securely fits inside cap 460 and reservoir 480.

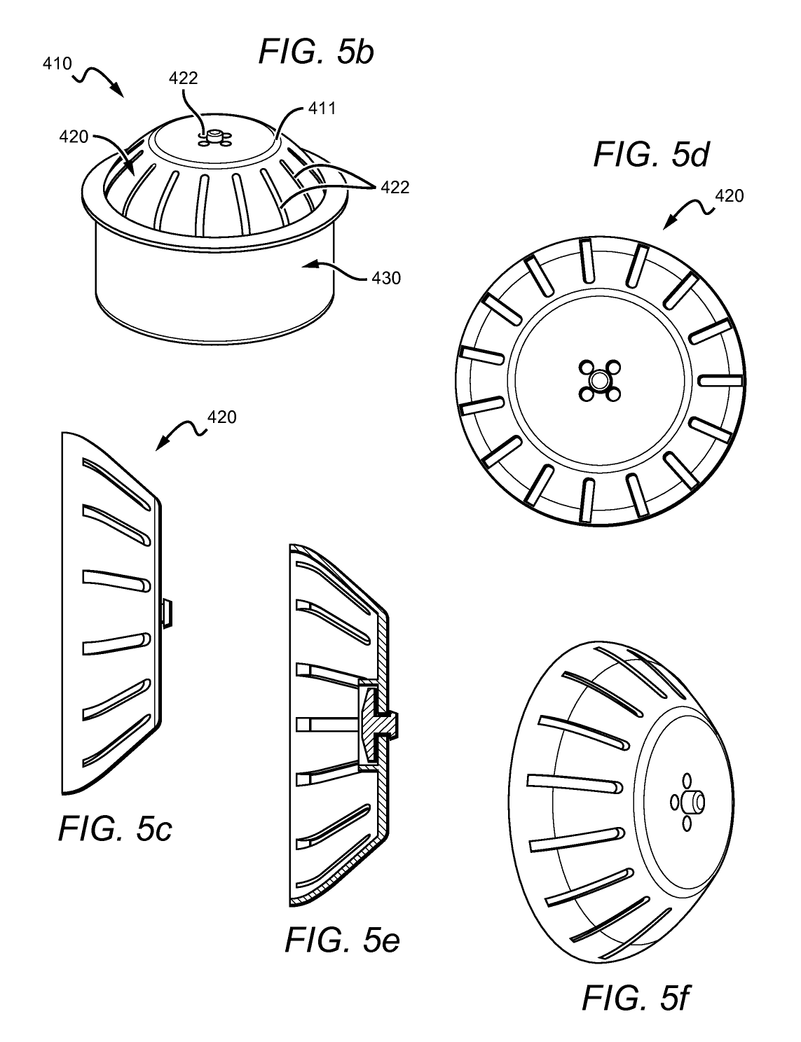

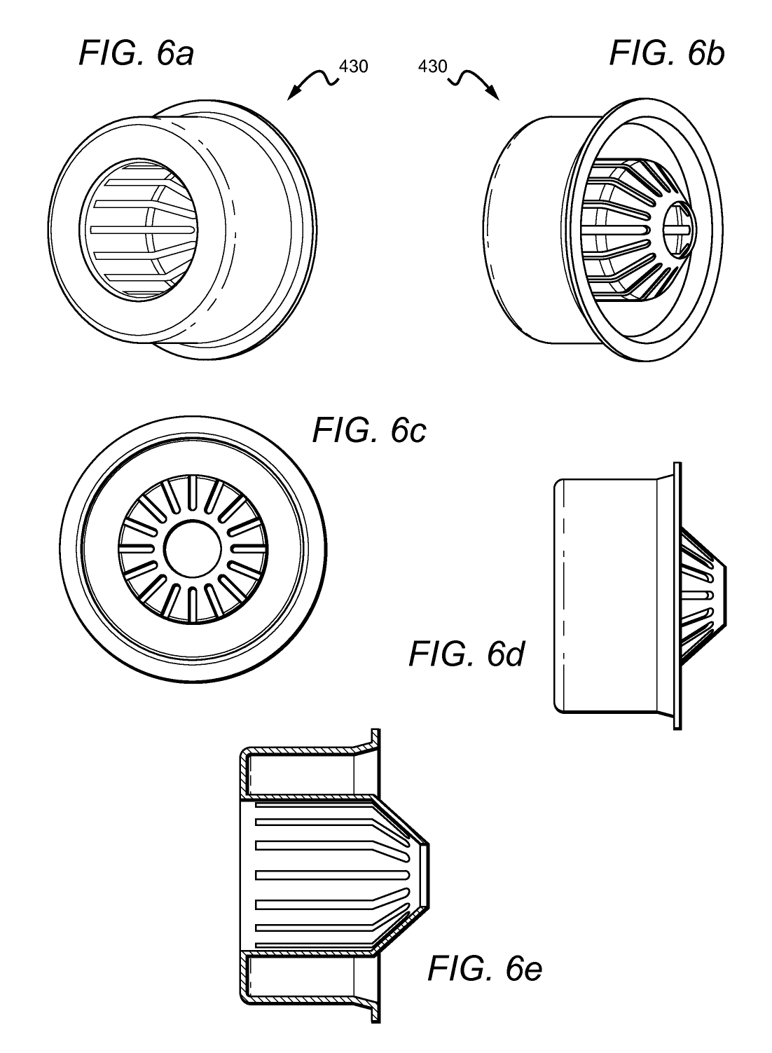

FIGS. 5a shows a bottom perspective view of cartridge 410, which comprises a top member 420 and a bottom member 430. FIG. 5b shows a top perspective view of cartridge 410. Cartridge 410 has a concave exterior surface 411 with openings 422. When cartridge 410 is inside bottle 400 and cap 460, and bottle 400 is not in use (i.e., bottle 400 is in an upright position), surface 411 helps water to drain back into reservoir 480 via openings 422. Surface 411 conforms to the interior contours of cap 460, allowing cartridge 410 to securely couple with cap 460 and reservoir 480 of bottle 400. FIGS 5c-f show various views of the top member 420. FIGS. 6a-e show various views of a bottom member 430.

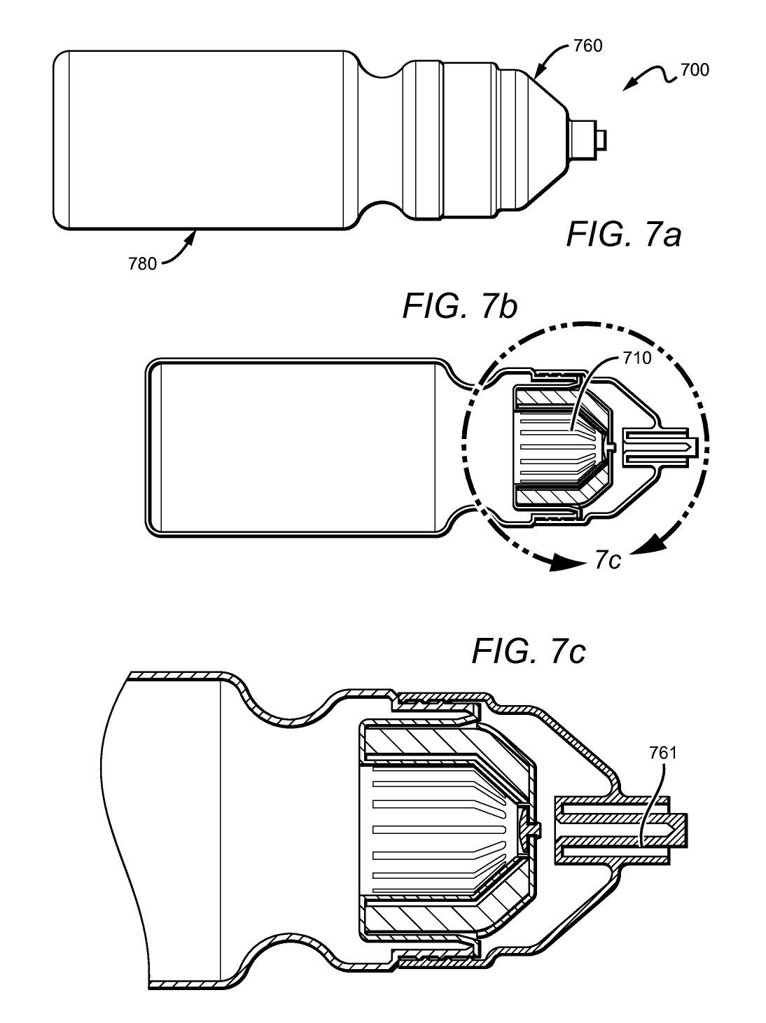

FIG. 7a shows a side view of a water bottle 700. FIG. 7b shows a cross section view of the bottle 700, exposing a filter cartridge 710. Cartridge 710 fits snugly and securely within reservoir 780 and cap 760. Cartridge 710 is configured such that water contained in reservoir 780 of bottle 700 must pass through cartridge 710 before exiting cap opening 761 (see FIG. 7c).

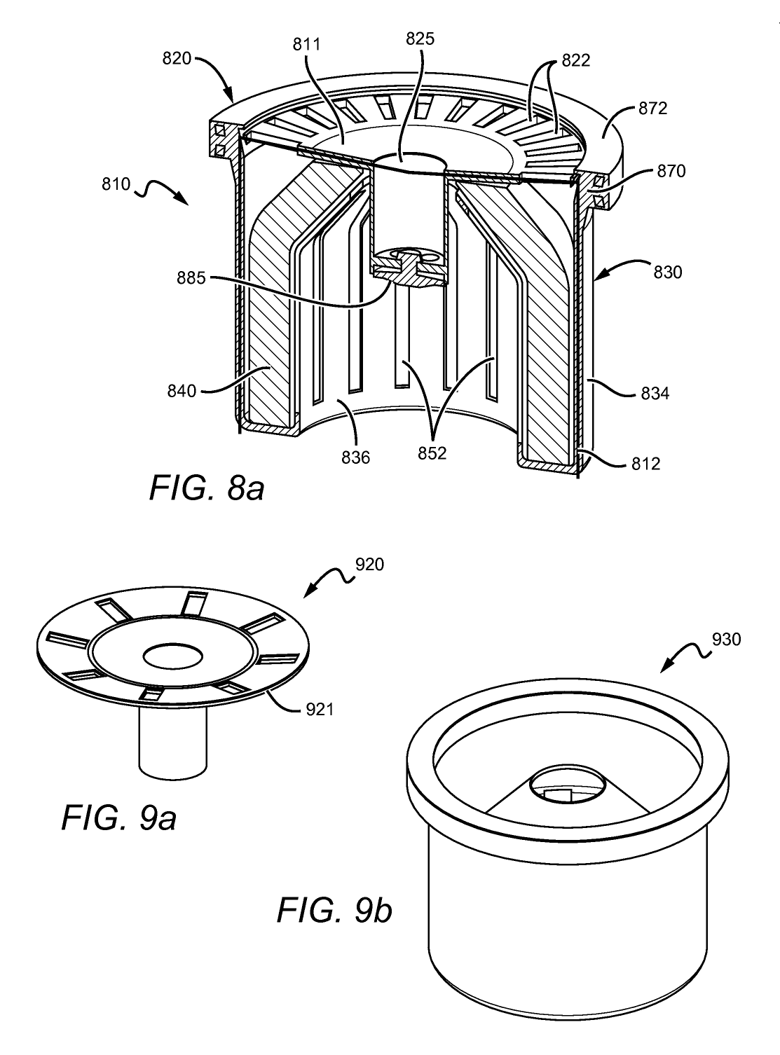

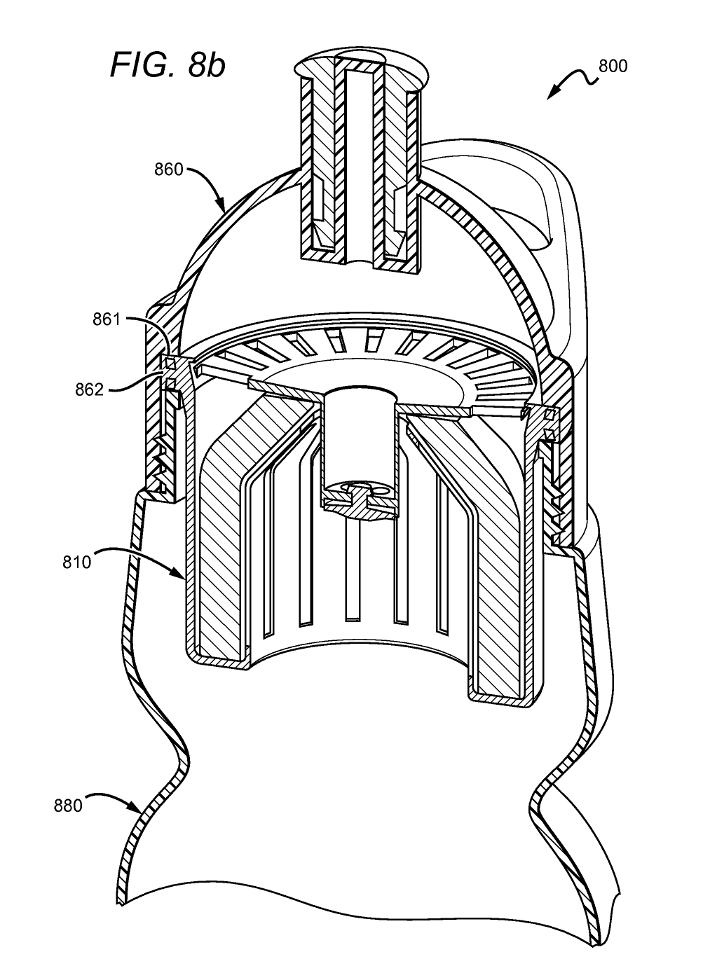

FIG. 8a shows a cross section view of a filter cartridge 810 having a substantially M-shaped cross section 812. As used herein, the term “substantially M-shaped cross section” is used broadly to include for example, a rounded m-shape, an m-shape having a large diameter, an m-shape having a small diameter, an m-shape having parallel sides, an m-shape having non-parallel sides, or any other suitable m-like cross section.

Cartridge 810 includes a top member 820 having openings 822 for dispensing and/or draining a liquid, and a bottom member 830 having inlets 852 to allow for liquid to flow through filter 840. In some embodiments, openings 822 can act solely to dispense a liquid, while recessed portion 825 can act solely to drain liquid. In other embodiments, openings 822 and/or recessed portion 825 can act as both a dispenser and a drainer. Cartridge 810 is designed to couple to a bottle, as shown in FIG. 8b.

Rim 870 includes a seal 872 that is ring-shaped and surrounding at least a portion of the ring to aid in leakage prevention. It is contemplated that seal 872 could comprise a soft plastic material, rubber material, or any other suitable material to assist in preventing leakage. Seal 872 could be over-molded around rim 870, or be partially embedded within a channel of a rim or any other portion of filter cartridge 810. Rim 870 may also be sized and dimensioned to allow cartridge 810 to be press fit into inner ring 862 (against annular shoulder 861) of cap 860.

As shown in FIG. 8a, top member 820 has an inwardly sloping exterior surface 811 having an substantially V-shaped cross-section that permits excess liquid to drain back through filter 840 via openings 822 and/or recessed portion 825 when cartridge 810 is not in use. It is contemplated that top member could alternatively comprise a substantially U-shaped cross-section.

Recessed portion 825 is placed near the center of exterior surface 811. However, in alternative embodiments, recessed portion 825 could be located away from the center of exterior surface 811 (e.g., on the inwardly sloping surface of top member 820).

Bottom member 830 includes inner and outer walls 836 and 834 that form a filter holding portion. Outer wall 834 comprises an imperforate tubular wall, but perforate and non-tubular walls are also contemplated. Inner wall 836 has a frustoconical portion and a tubular portion. However, it is contemplated that inner wall 836 could comprise other shapes suitable for housing a filter.

Filter cartridge 810 can be constructed out of polyethylene, polypropylene, polyvinyl chloride, polyethylene terepthalate, or any other suitable natural and synthetic polymer. Filter cartridge 810 is sized and dimensioned to house filter 840.

Filter 840 comprises a solid component, sometimes referred to as a “block.” In alternative embodiments, filter 840 could comprise a woven or non-woven mesh fabric (e.g. filter 1245) enclosing filter elements (e.g. 1247) to aid in the filtration of viruses, bacteria, giardia, microbial cysts and other submicron particles, as shown in FIG. 12. For example, a nonwoven mesh composed of nano-fibers, such as AHLSTROM DISRUPTOR® Nonwoven Filter Media, which has nano-fibers that are 2 nm in diameter and 250 nm in length, and thus have a surface area of >500 gsm, and which create a natural positive charge that aids in the absorption of the contaminant.

In some embodiments, the filter can be molded into a cone, concave, or frustoconical shape. It is also contemplated that a filter could be molded into a flat disc, a combination of a flat and frustoconical disc, or any other size and shape. It is further contemplated that the filter could be a combination of stackable discs or rings rather than one solid block.

FIG. 8b shows filter 840 disposed within bottle 800. The top member 820 or bottom member 830 comprises a rim 870 that fits in place between reservoir 880 and cap 860. Cap 860 has an inner ring 862 having an inner annular shoulder 861. Rim 870 is disposed between an upper ring of the reservoir 880 and the inner annular shoulder 861 of inner ring 862. Rim 870 is sized and dimensioned such that it rests on the opening of reservoir 880 when placed therein. Rim 870 is also sized and dimensioned to snugly fit inside cap 860 such that when cap 860 is unscrewed from reservoier 880 and lifted up, cartridge 810 remains inside cap.

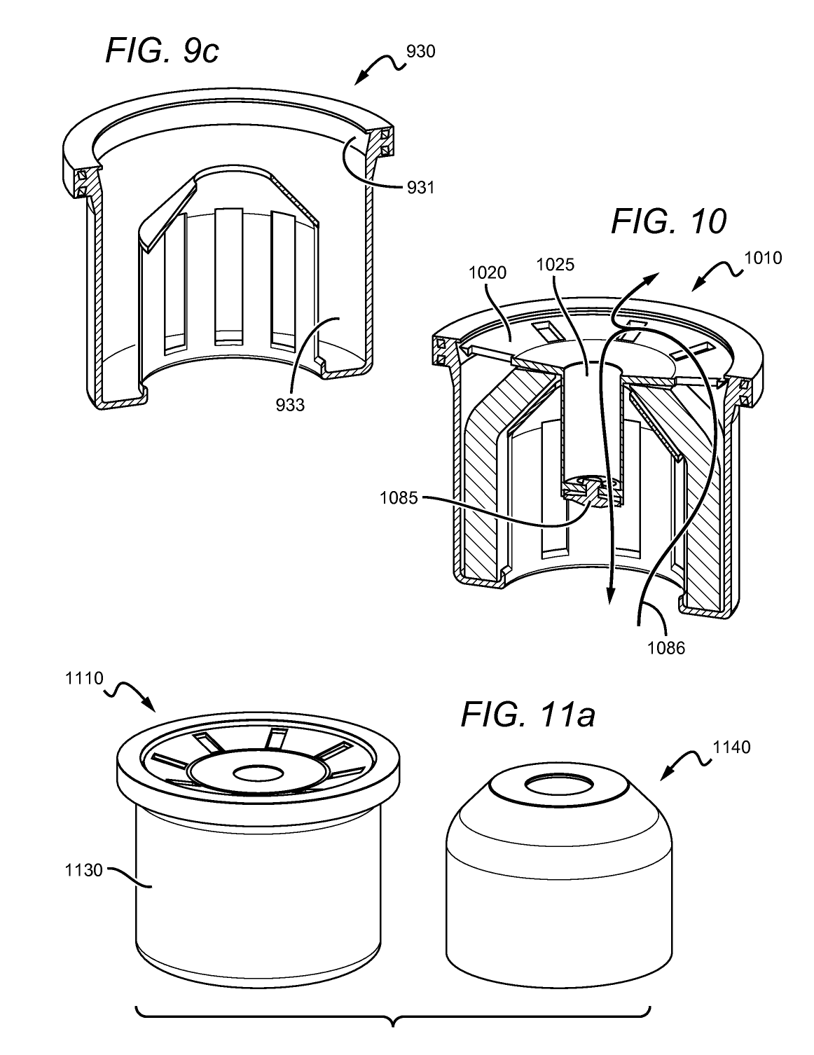

FIG. 9a shows a filter cartridge top member 920 and FIG. 9b shows a filter cartridge bottom member 930. Top member 920 has an outer portion 921 that is configured to snap fit into annular ridge 931 of an interior portion 933 of bottom member 930. It is contemplated that top member 920 and bottom member 930 can additionally or alternatively be removably coupled together via a quick release mechanism, magnet, threads, or any other suitable means known in the art that are capable of removably coupling top member 920 with bottom member 930. In other embodiments, top member 920 could be permanently coupled with bottom member 930.

FIG. 10 shows a cross sectional view of a filter cartridge 1010 having a top member 1020. Top member 1020 comprises a recessed portion 1025, which comprises valve 1085. Valve 1085 can be a one-way valve that ensures that water from the reservoir flows through path 1086. Thus, valve 1085 ensures that (1) unfiltered liquid from the reservoir cannot bypass the filter, and (2) filtered water can drain from above the top member 1020 and into the reservoir so that it does not sit above top member 1020 for extended periods of time. In some embodiments, valve 1085 could comprise a pressure equalization valve.

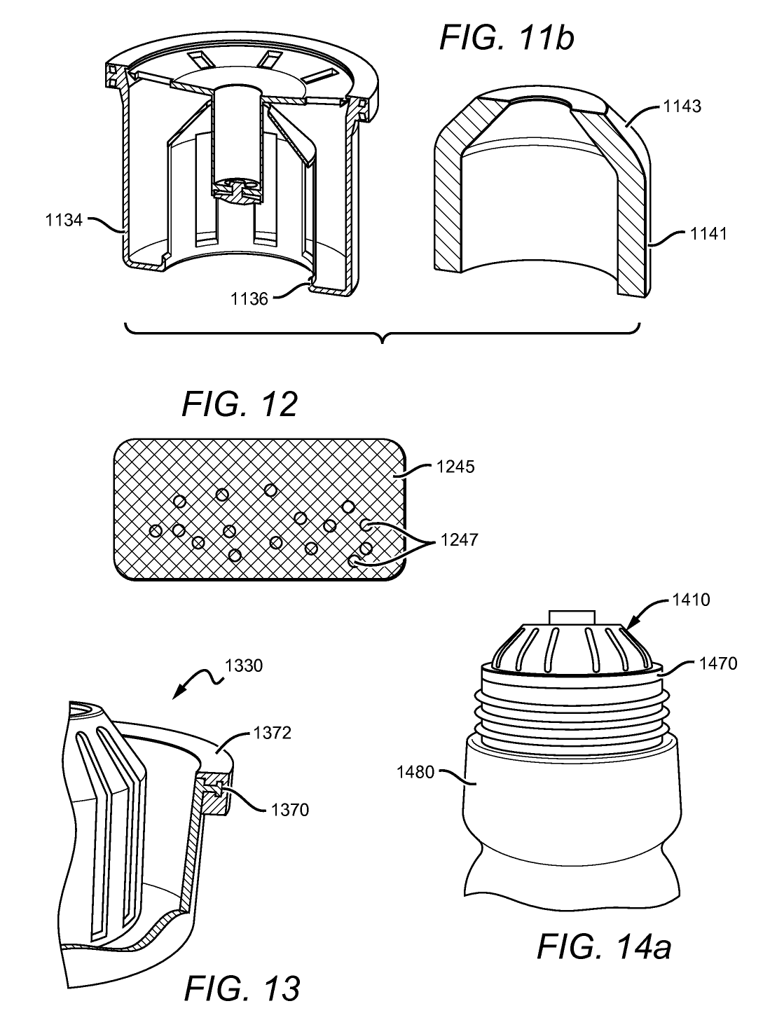

FIG. 11a shows one embodiment of a filter 1140 removed from filter cartridge 1110. FIG. 11b is a cross-sectional view thereof. In FIGS. 11a and 11b, filter 1140 is a filter block having a cylindrical shaped lower portion 1141 and a frustoconical shaped upper portion 1143. Bottom member 1130 has a tubular outer wall 1134 and a frustoconical-tubular inner wall 1136. Filter 1140 fits inside filter cartridge 1110 between inner wall 1136 and outer wall 1134. The configuration of cartridge 1110 and filter 1140 provide increased surface area for filtering liquid and improves liquid flow rate.

FIG. 13 is a cutaway view of a bottom member 1330. Bottom member 1330 comprises a rim 1370 having a substantially H-shaped cross-section. Rim 1370 is substantially surrounded by seal 1372, which can be beneficial to prevent leakage of a liquid when filter cartridge is coupled with a bottle.

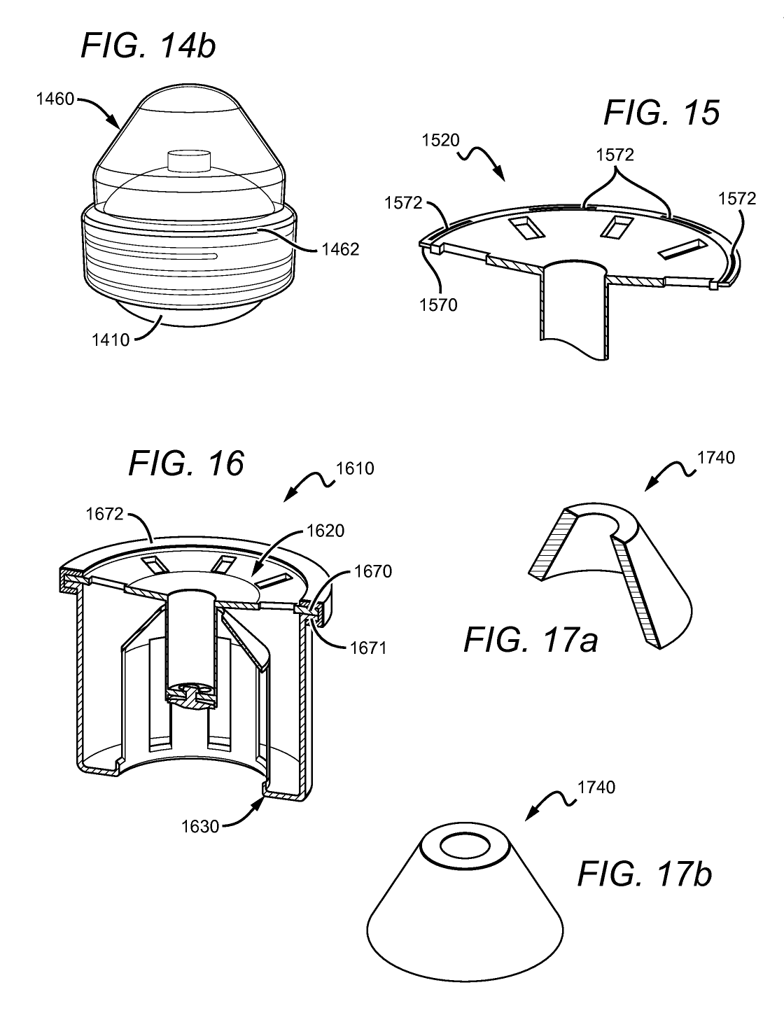

FIG. 14a shows filter cartridge 1410 coupled with reservoir 1480. Rim 1470 of bottom member 1430 (disposed mostly within reservoir 1480) rests on top of an open top of reservoir 1480. In alternative embodiments, the rim of a top member or a bottom member of a filter cartridge could be sized and dimensioned to snugly fit within an interior surface of a reservoir.

FIG. 14b shows filter cartridge 1410 of FIG. 14a coupled with cap 1460. In FIG. 14b, rim 1470 (disposed within cap 1460) snap fits into an inner ring 1462 of cap 1460. When cap 1460 is removed from reservoir 1480 as shown, filter cartridge 1410 remains inside cap 1460 until a user pulls filter cartridge 1410 out of cap 1460.

FIG. 15 shows a cross section view of a top member 1520 having a rim 1570 and at least four seals 1572 disposed partially within channels of rim 1570. Unlike the filter cartridge embodiments previously disclosed, rim 1570 is disposed on a top member 1520 rather than a bottom member of a filter cartridge. Rims and flanges can be disposed on either the top or bottom member of a filter cartridge, or even on both the top and bottom members.

FIG. 16 shows a cross section view of an annular seal 1672 that is folded over a portion of each of a first rim 1670 on top member 1620 and a second rim 1671 on bottom member 1630 of filter cartridge 1610. Seal 1672 couples top member 1620 with bottom member 1630 and also couples filter cartridge 1610 with a cap (not shown) as previously described.

FIGS. 17a-b show a filter 1740 comprising a frustoconical shape. Unlike the filter blocks previously disclosed, filter 1740 is entirely frustoconical and lacks a cylindrical portion. Filter 1740 can be used in combination with filter cartridges that have substantially frustoconical outer and inner walls.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A filter cartridge for housing a filter, comprising:
a top member having an inwardly sloping exterior surface, a plurality of openings and a first recessed portion;
a bottom member coupled to the top member and having a plurality of inlets;
wherein the top and bottom members couple with each other to form an enclosure sized and dimensioned to house the filter;
wherein at least one of the top and bottom members comprise a first flange;
wherein a first seal covers at least a portion of the first flange; and
wherein the filter cartridge is configured to couple to a bottle opening.

2. The filter cartridge of claim 1, wherein top member couples to the bottom member by a snap fitting.

3. The filter cartridge of claim 1, wherein the bottom member includes inner and outer concentric walls that form a cavity sized and dimensioned to house the filter.

4. The filter cartridge of claim 1, wherein the filter comprises a frustoconical portion and securely attached to an inner surface of the filter cartridge.

5. The filter cartridge of claim 1, wherein the filter is a replaceable cartridge configured to removeably couple to an inside portion of the filter cartridge.

6. The filter cartridge of claim 1, wherein the filter comprises at least one of activated carbon, high reactivity carbon mixture (HCRM), and iodinated resin.

7. The filter cartridge of claim 1, wherein the filter is molded and has a cylindrical shape.

8. The filter cartridge of claim 1, wherein the filter is capable of reducing contaminants in the liquid by at least 99%.

9. The filter cartridge of claim 1, wherein the filter comprises a mesh fabric and filter elements capable of filtering out at least one of bacteria, giardia and microbial cysts.

10. The filter cartridge of claim 1, wherein the filter cartridge includes an air valve for equalizing air pressure.

11. A bottle, comprising:
a cap having a dispensing portion, internal threading, and an inner ring having an inner annular shoulder;
a reservoir having an open top and external threading that mates with the internal threading;
a filter having a cylindrical shaped lower portion and a frustoconical shaped upper portion;
a filter cartridge for housing the filter comprising a top member coupled with a bottom member;
wherein the top member has a substantially v-shaped cross section
wherein at least one of the top member and the bottom member comprises an annular flange; and
wherein the annular flange is coupled to the inner annular shoulder of the cap such that a liquid in the reservoir is filtered by the filter as the liquid is being consumed, and the filter is fluidly decoupled from the reservoir when the cap is disengaged from the reservoir.

12. The bottle of claim 11, wherein an outer portion of the top member is configured to snap fit into an annular ridge in an interior portion of the bottom member.

13. A filter cartridge for housing a filter, comprising:
a top member having an inwardly sloping exterior surface, a plurality of openings, a first flange, and a first recessed portion;
a bottom member coupled to the top member and having a plurality of inlets and a second flange;
a seal that covers at least a portion of each of the first and second flanges;
wherein the top and bottom members couple with each other to form an enclosure sized and dimensioned to house the filter; and
wherein the filter cartridge is configured to couple to a bottle opening.
